(19) United States
(12) Patent Application Publication
(10) Pub. No.: US 2011/0227723 A1
(43) Pub. Date: Sep. 22, 2011

(54) REMOTE MACHINE MONITORING

(75) Inventors: Robert John Dewey, East Schodack, NY (US); John Neil Baker, Dallas, GA (US); Thomas Gene Gustafson, Marietta, GA (US); Mills Thomas Robinson, JR., Virginia Beach, VA (US); Michael Edward Sopko, Roanoke, VA (US)

(73) Assignee: General Electric Company, Schenectady, NY (US)

(21) Appl. No.: 12/725,858

(22) Filed: Mar. 17, 2010

(51) Int. Cl. G08B 1/08; G06F 15/00

(52) U.S. Cl. 340/539.11; 702/188

(57) ABSTRACT

A system for monitoring a machine includes a monitoring relay for coupling to one or more sensors on the machine and a communication device. The system also includes a remote monitoring unit (RMU) coupled to the monitoring device and the communication device, the RMU receiving data points from the monitoring relay and causing the data points to be provided over a communication to a server via an HTTP POST command.

### BACKGROUND OF THE INVENTION

The subject matter disclosed herein relates monitoring and diagnostics and, in particular, to remote monitoring and diagnostics for machines.

The high cost of unreliability and forced outages of machines is well known. Improper maintenance or operational anomoly detection may lead to machine-forced outages. Early detection of such anomolies is important in preventing and reducing lengthy machine forced outages. This may be particularly prevelant in the context of motors. Accordingly, the following description may focus on motors but the teachings are not limited to motors and could be applied to any machine from which data may extracted.

Mechanical machines, such as motors, may need inspection from time to time to ensure proper operation. One approach has been to have periodic inspections. In some cases, however, it may be determined that a particular machine (or portions thereof) may not need to be inspected as often as others even if they are of the same type. Thus, an inspection may not be necessary for one machine while it may be for another. One factor that may influence such decisions is based on environmental conditions where the machine is located or how it is operated.

A typical inspection may require that a motor be shut down during the inspection. In such a case, at least a portion of a plant's production capability may be hampered. Reducing the ability to operate may have real economic costs associated with it. In addition, the inspection itself costs money. Remote monitoring and diagnostics for motors may allow for shortening of outages and prediction of inspection intervals through remote monitoring of variables that identify motor health problems.

One approach to getting data from a remote location to a monitoring location required a hard wire connection to a computer network at the site where the motor was located. This connection required extensive lengths of Ethernet or serial cable to connect a diagnostic computer to a monitoring relay. Installation of the cable increases installation costs dramatically. In addition, such a solution led to network firewall communication issues in the event that the motor and the monitoring were done by different corporate entities having different corporate firewalls.

### BRIEF DESCRIPTION OF THE INVENTION

According to one aspect of the invention, a system for monitoring a machine is provided. The system of this embodiment includes a monitoring relay for coupling to one or more sensors on the machine and a communication device. The system of this embodiment also includes a remote monitoring unit (RMU) coupled to the monitoring device and the communication device that receives data points from the monitoring relay and causes the data points to be provided over a communication network to a server via an HTTP POST command.

According to another aspect of the invention, a method of monitoring a machine is disclosed. This method includes receiving data points at a computing device from a monitoring relay coupled to the machine; analyzing the data points in the computing device; causing an alarm notification to be sent to a first device; and providing the data points to a second device over a communication network.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram of a system according to one embodiment of the present invention;

FIG. 2 is a more detailed block diagram of portions of the system shown in FIG. 1; and

FIG. 3 is flow chart showing a method according to one embodiment of the present invention.

The detailed description explains embodiments of the invention, together with advantages and features, by way of example with reference to the drawings.

### DETAILED DESCRIPTION OF THE INVENTION

In one embodiment, the present invention provides for communication between a machine and a remote data center. In one embodiment, the present invention provides a machine coupled to a remote monitor unit (RMU). The RMU may be attached to a remote monitoring relay. The relay may be located, for example, in a motor control cabinet (MCC) and coupled to a motor. Of course, the remote monitoring relay may be coupled to any type of machine, not just a motor.

The RMU may run a local algorithm that acquires operational data for the machine. For example, the RMU may acquire motor operating condition data points. The local algorithm monitors the data points and compares them against ranges that are identified for safe operation. Upon a diversion from the safe operation zone, an alarm is generated and may be logged.

In addition, though a communications network, upon detection of a change in any of the data points, upon the detection of an alarm condition, or at a periodic interval, the operating data points may be transferred via an HTTP POST command to a remote data center for monitoring and diagnostics and for storage. In addition, in the event of an alarm, the RMU may cause one or more individuals to be notified of the alarm condition in addition to providing the information to the remote data center.

In one embodiment, the RMU may be coupled to a wireless communication device to allow for wireless communication over a cellular network to the remote data center. This may allow for the elimination of corporate firewall conflicts. In one embodiment, upon detection of an alarm condition, a notification via a text message, e-mail or other digital communication method may also be sent via the cellular network.

Providing the data points to the remote data center may also provide additional abilities related to the machine. For example, a connection to the remote data center may allow users to access historical machine data points and alarm data to view performance over time. This data may allow for life expectancy predictions or repair scheduling.

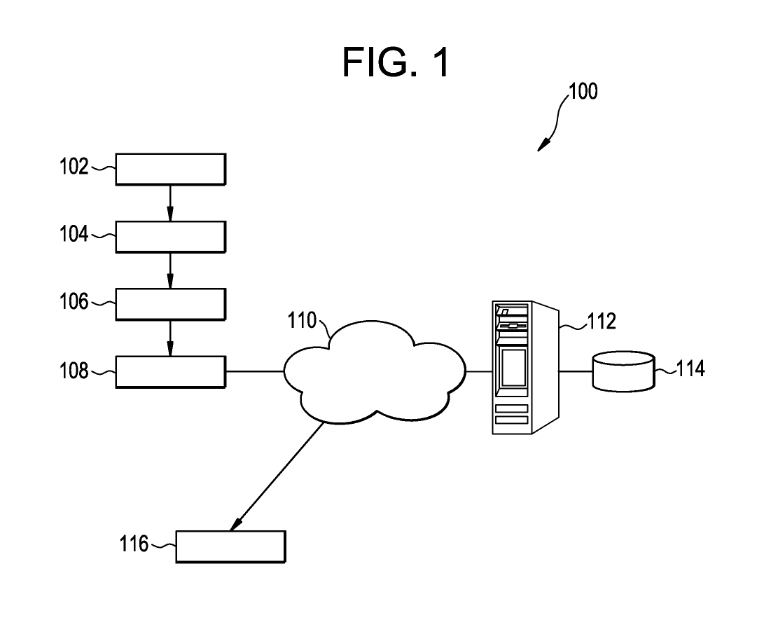

FIG. 1 shows an example of a system 100 according to one embodiment of the present invention. The system 100 includes a machine 102. The machine 102 may be any type of mechanical machine. In one embodiment, the machine 102 is a motor. In one embodiment, the machine 102 is connected to a monitoring relay 104.

The monitoring relay 104 may be, in one embodiment, motor management relay. A monitoring relay 104 receives data from the machine 102. Based on the received values, the monitoring relay 104 may cause power to be cut-off or otherwise varied in some instances. In addition, the monitoring relay may provide for control and communications with the machine 102. In addition, a monitoring relay 104 may include the ability to provide diagnostics and data points (data values).

In one embodiment, the monitoring relay 104 may be coupled to one or more sensors acquiring information from the machine 102. The sensors may include, for example, temperature, current, voltage and vibration sensors as well as other sensors. In the event that the monitoring relay 104 is a motor management relay, it may be located in a motor control cabinet (MCC).

The values received from the sensors on the machine 102 by the monitoring relay 104 may be provided to a remote monitoring unit 106. The remote monitoring unit (RMU) 106 may be any type of computing device. In one embodiment, the RMU 106 may include circuits (implemented in hardware, software or a combination thereof) that allow for various values to be calculated based on the sensor information. In one embodiment, these values may include, but are not limited to, drive end (DE) bearing temperature; opposite drive end (ODE) bearing temperature; DE bearing vibration (vertical direction); DE bearing vibration (horizontal direction); ODE bearing vibration (vertical direction); ODE bearing vibration (horizontal direction); stator temperature; ambient temperature; phase voltage; and phase current.

In addition, the RMU 106 may include circuits (implemented in hardware, software or a combination thereof) that, based on the received inputs, may determine if the values are within acceptable ranges. If not, the RMU 106 may generate an alarm.

The RMU 106 may be coupled to a communication device 108. The communication device 108 allows for communication between the RMU 106 and a communication network 110. In one embodiment, the communication device 108 is a wireless communication device. For example, the communication device 108 may be a wireless modem.

The communication network 110 may be any communication network and may include one or more types of networks. For example, the network 110 may include a cellular network coupled to the Internet.

The system 100 may also include a server 112 coupled to the network 110. The server 112 may, in one embodiment, be coupled to a database 114. The database 114 may store information from one or more machines for later use. Information from the RMU 106 is provided to the communication device 108 and transferred over the network 110 to the server 112.

In one embodiment, the RMU 106 periodically transfers one or more data values to the server 112. In addition, the RMU 106 may cause one or more data values to be transferred when one or more of the data values changes or when an alarm is detected.

In one embodiment, the system 100 may also include one or more personal notification devices 114. In the event an alarm generated, the RMU 106 may cause the communication 108 to send an electronic message over the network to the personal notification device 114 to notify one or more persons of the alarm. This notification may be sent when the alarm is generated in one embodiment. The alarm may be in addition to a status update sent to the server 112. In one embodiment, the alarm notification is sent before the update is sent. The alarm notification may be, for example, an email, a text or instant message, or any other type of electronic communication.

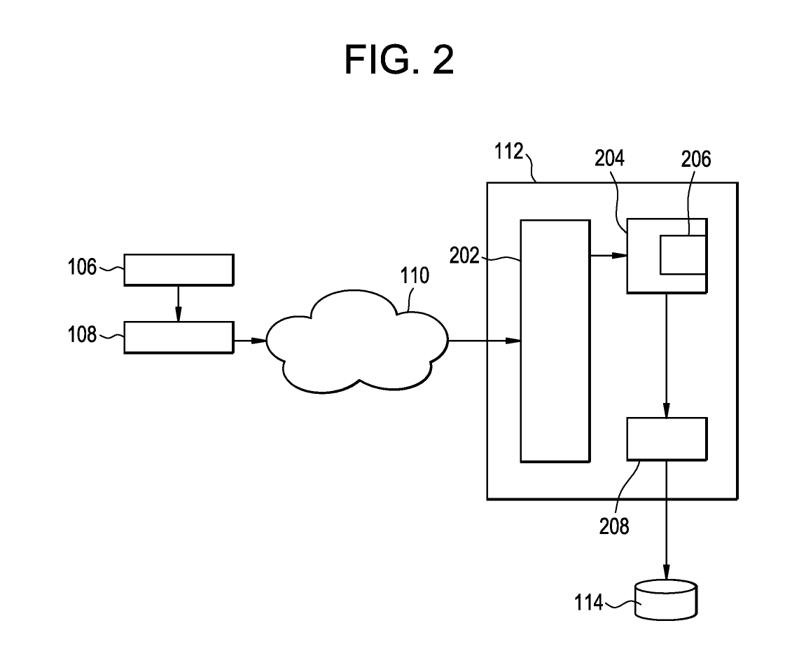

FIG. 2 is dataflow diagram showing the transfer of information from the RMU 106 to the server 112 according to one embodiment. In this embodiment, the RMU 106 “posts” information to the server 112.

In more detail, the RMU 106 provides data to be transferred to the server 112 via communication device 108 over the communication network 110. The server 112 may include a receiving location 202. The receiving location 202 may, in one embodiment, be a web page having a particular uniform resource identifier (URI). The receiving location 202 may be coupled to a servlet engine 204 that includes a forms listening module 206.

The servlet engine 204 supports the receiving location 202 in a manner such that the receiving location 202 may receive an HTML POST from the RMU 106. In computing, an HTTP POST is a type of HTTP request message for filling in a form. A POST may be used when the requested action may change data on the server 112, such as updating data in database 114. The POST request (made by RMU 106 to receiving location 202) may be supported by the forms runtime processor 208, the forms listening module 206, and the servlet engine 204.

In one embodiment, the POST request is made each time that a data value being monitored changes. Of course, the POST requests could also be periodic. In one embodiment, the POST request includes the URI of the receiving location 202, an identifier for a particular machine and the data being sent to the server 112.

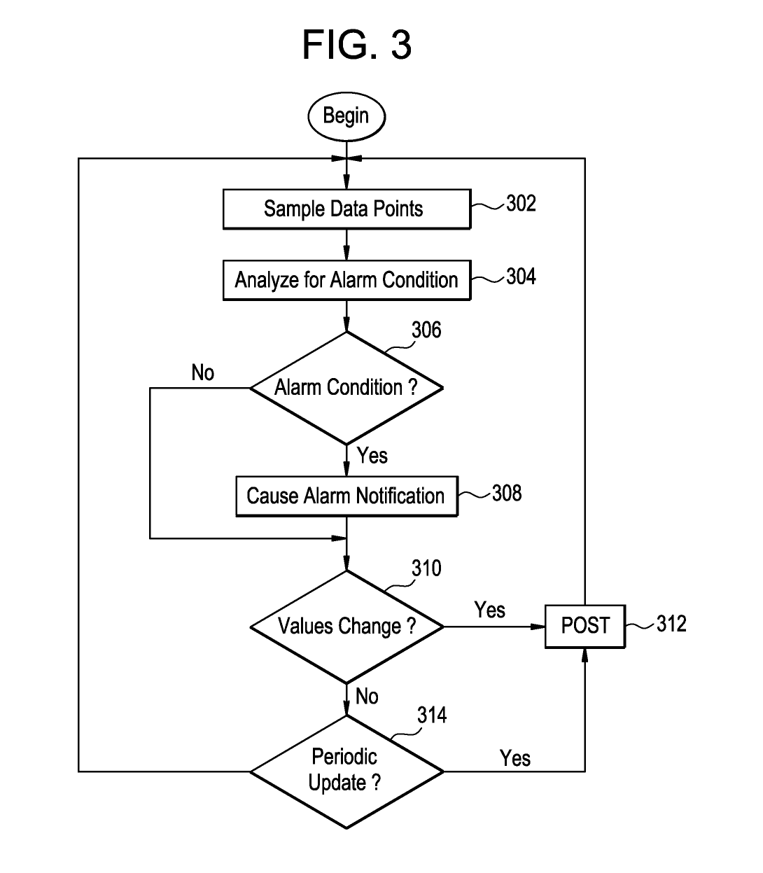

FIG. 3 is flow chart showing one method of updating machine information to a server. At a block 302 data points are sampled. These data points may be any type of data associated with any type of machine. In one embodiment, the data points are sampled by a monitoring relay located at the same location as the machine and provided to an RMU. In one embodiment, the machine may be a motor. In such an embodiment, the data points may include, but are not limited to, DE bearing temperature; ODE bearing temperature; DE bearing vibration (vertical direction); DE bearing vibration (horizontal direction); ODE bearing vibration (vertical direction); ODE bearing vibration (horizontal direction); stator temperature; ambient temperature; phase voltage; and phase current.

At a block 304, the data points are analyzed to determine if any of the data points are outside of normal or acceptable ranges. At decision block 306 it is determined to if any alarm conditions exist. If so, at a block 308 an alarm notification is created and sent to one or more individuals. The alarm notification may be, for example, an email, a text or instant message, or any other type of electronic communication. If an alarm does not exist, processing proceed to a block 310.

At block 310 it is determined if any of the data values has changed. If so, the values are posted to the server at a block 312. Otherwise, at a block 314 it is determined if it is time for a periodic update. If so, the values are posted to the server at a block 312. Otherwise, processing returns to block 302.

As is made clear by the description of FIG. 3, in one embodiment three different events will cause an update: 1) an alarm; 2) a value change; and 3) a periodic update.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system for monitoring a machine, the system comprising:
a monitoring relay for coupling to one or more sensors on the machine;
a communication device; and
a remote monitoring unit (RMU) coupled to the monitoring relay and the communication device, the RMU receiving data points from the monitoring relay and causing the data points to be provided over a communication network to a server via an HTTP POST command.

2. The system of claim 1, wherein the machine is a motor and the monitoring relay is a motor monitoring relay.

3. The system of claim 1, wherein the RMU causes the data points to be updated whenever one of the data points changes.

4. The system of claim 1, wherein the RMU causes an alarm notification to be sent though the communication device to an electronic device other than the server in the event one or more of the data points indicates that an alarm condition is present.

5. The system of claim 1, wherein the communication device is a wireless communication device.

6. The system of claim 1, further comprising:
a server configured to provide a receiving location.

7. The system of claim 6, wherein the receiving location is a HTTP site capable of receiving an HTTP POST.

8. The system of claim 1, further including:
a communication network that includes the Internet and a cellular network.

9. A method of monitoring a machine, the method comprising:
receiving data points at a computing device from a monitoring relay coupled to the machine;
analyzing the data points in the computing device;
causing an alarm notification to be sent to a first device; and
providing the data points to a second device over a communication network.

10. The method of claim 9, wherein the alarm notification is sent before the data points are provided to the second device.

11. The method of claim 9, wherein providing includes:
performing an HTTP POST of the data points to a web site.

12. The method of claim 11, wherein the data points are provided over a wireless network.

13. The method of claim 9, wherein the machine is a motor and the monitoring relay is a motor monitoring relay.
